(19) United States
(12) Patent Application Publication
(10) Pub. No.: US 2025/0184121 A1
(43) Pub. Date: Jun. 5, 2025

(54) METHOD AND SYSTEM FOR COLLECTING CONSUMPTION DATA MEASURED BY SMART METERS

(71) Applicant: SAGEMCOM ENERGY & TELECOM SAS, Bois-Colombes (FR)

(72) Inventor: Henri TEBOULLE, Bois-Colombes (FR)

(73) Assignee: SAGEMCOM ENERGY & TELECOM SAS, Bois-Colombes (FR)

(21) Appl. No.: 18/962,777

(22) Filed: Nov. 27, 2024

(30) Foreign Application Priority Data
Nov. 30, 2023 (FR) 2313313

(51) Int. Cl. H04L 9/08; H04L 67/12

(52) U.S. Cl. CPC H04L 9/0825; H04L 67/12

(57) ABSTRACT

An automated management system comprises a first information system and a second information system. The automated management system also comprises smart meters of a first type and smart meters of a second type. A pairing is made between each smart meter of a second type and a said smart meter of the first type, so as to serve as relays for collecting consumption data. A first secure link is established between each smart meter of the first type and the first information system, by means of an asymmetric encryption for collecting first consumption data. A second secure link is established between each smart meter of the second type and the second information system, by means of an asymmetric encryption for collecting consumption data using the smart meter of the first type paired as a relay.

### TECHNICAL FIELD

At least one embodiment relates to a method and a system for collecting consumption data measured by a smart meter. The system in question is adapted to make a collection of such data coming from a plurality of smart meters, whether for measurements of consumption of fluid (such as gas, water, heat, petrol) or electrical-consumption measurements.

### PRIOR ART

Smart meters are known, of the electricity meter type (electricity consumption meters) or fluid meters (fluid-consumption meters), which comprise communication interfaces enabling an automated management system to make a remote collection of consumption data. For example, smart electricity meters comprise a communication interface of the powerline communications (PLC) type. Consumption data can thus be transmitted, at regular intervals or not, to an information system IS processing them in a centralised manner.

The consumption data collected must be free from errors to avoid any disputes related to a contesting of their values. Errors may stem in particular from an alteration during transmission thereof. In the case of a dispute about consumption data value between a customer and a service provider, one solution consists of the service provider sending to the customer an operator to make a direct reading of the consumption data on a display of the meter. Such a solution is not satisfactory since it requires firstly the meter being equipped with a display and secondly the operator travelling to the home of the customer, which is tedious and expensive.

It is then desirable to provide a solution that makes it possible to certify that the consumption data collected remotely from a smart meter by an information system do indeed come from said smart meter. It is in particular desirable to provide a solution that makes it possible to easily change an existing collection infrastructure (i.e. one already deployed in the field) while ensuring that the consumption data collected are not repudiated.

### DISCLOSURE OF THE INVENTION

For this purpose, a method is proposed for collecting, in an automated management system, first consumption data by a first information system of the automated management system and second consumption data by a second information system of the automated management system, the automated management system furthermore comprising a data concentrator to which the first and second information systems respectively delegate the collection of the first and second consumption data, the automated management system furthermore comprising a communication network via which the data concentrator is connected to smart meters of a first type, the method being such that:
a pairing is made between each smart meter of a second type and a said smart meter of the first type, so as to serve as relays for collecting consumption data from the smart meter of the second type in question,
a first secure link is established between each smart meter of the first type and the first information system, the first secure link being such that an asymmetric encryption is established to transmit the first consumption data from the smart meter of the first type in question and the first information system;
a second secure link is established between each smart meter of a second type and the second information system, the second secure link being such that an asymmetric encryption is established to transmit the second consumption data from the smart meter of the second type in question and the second information system using the smart meter of the first type paired as a relay;
the data concentrator switches consumption data received through the communication network coming from a said smart meter of the first type, either to the first information system or to the second information system, on the secure link to which said received data relate from the first and second secure links.

Thus, by means of the secure links, each information system remains the master of the consumption data coming from the smart meters that relate to them. The information systems do not have to exchange with each other, although sharing one and the same network infrastructure (communication network, data concentrator). Asymmetric encryption ensures non-repudiation of the data.

In a particular embodiment, each smart meter of the second type operates on batteries, and the smart meter of the first type serving as a relay for the smart meter of the second type in question programs times for the smart meter of the second type in question to wake up to obtain the second consumption data to be relayed via the communication network. Thus consumption data of smart meters operating on batteries are easily collected.

In a particular embodiment, at least one smart meter of the first type paired operates on batteries, and the smart meter of the first type in question programs its own times for waking up, so as to be awakened when each smart meter of the second type paired with the smart meter of the first type in question wakes up. Thus the batteries of the smart meter of the first type paired are best preserved with regard to the collection of consumption data of the smart meters of the second type.

In a particular embodiment, each smart meter of the second type communicates in a secure manner by symmetric encryption with the smart meter of the first type paired that serves as a relay for it, the smart meter of the first type in question obtaining a symmetric encryption key to be used with the smart meter of the second type in question from the second information system. Thus the symmetric encryption supplements the asymmetric encryption to provide more security.

In a particular embodiment, each smart meter of the second type provides to the smart meter of the first type paired that serves as a relay for it an address of an item of equipment of the second information system from which to obtain the symmetric encryption key to be used with the smart meter of the second type in question.

In a particular embodiment, each smart meter of the first type communicates in a secure manner by symmetric encryption with the data concentrator, the data concentrator obtaining an asymmetric encryption key to be used with the smart meter of the first type in question from the first information system. Thus the symmetric encryption supplements the asymmetric encryption to provide more security.

There is also proposed here an automated management system configured to make a collection of first consumption data by a first information system of the automated management system and of second consumption data by a second information system of the automated management system, the automated management system furthermore comprising a data concentrator to which the first and second information systems respectively delegate the collection of the first and second consumption data, the automated management system furthermore comprising a communication network via which the data concentrator is connected to smart meters of the first type. The automated management system is such that each smart meter of the first type, each smart meter of the second type, the data concentrator, the first information system and the second information system comprise electronic circuitry configured so that:
a pairing is made between each smart meter of a second type and a said smart meter of the first type, so as to serve as relays for collecting consumption data from the smart meter of the second type in question,
a first secure link is established between each smart meter of the first type and the first information system, the first secure link being such that an asymmetric encryption is established to transmit the first consumption data from the smart meter of the first type in question and the first information system;
a second secure link is established between each smart meter of a second type and the second information system, the second secure link being such that an asymmetric encryption is established to transmit the second consumption data from the smart meter of the second type in question and the second information system using the smart meter of the first type paired as a relay;
the data concentrator switches consumption data received through the communication network coming from a said smart meter of the first type, either to the first information system or to the second information system, on the secure link to which said received data relate from the first and second secure links.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1A illustrates schematically an automated management system for collecting consumption data;

FIG. 1B illustrates schematically an arrangement of an information system of the automated management system;

FIG. 2 illustrates schematically an example of hardware architecture that is adapted to implement a device of the automated management system;

FIG. 3 illustrates schematically exchanges occurring in the automated management system for collecting consumption data;

FIG. 4 illustrates schematically details of first operations performed in the context of the exchanges of FIG. 3, in one particular embodiment;

FIG. 5 illustrates schematically details of second operations performed in the context of the exchanges of FIG. 3, in one particular embodiment;

FIG. 6 illustrates schematically details of third operations performed in the context of the exchanges of FIG. 3, in one particular embodiment;

FIG. 7 illustrates schematically details of fourth operations performed in the context of the exchanges of FIG. 3, in one particular embodiment; and

FIG. 8 illustrates schematically details of fifth operations performed in the context of the exchanges of FIG. 3, in one particular embodiment.

### DETAILED DISCLOSURE OF EMBODIMENTS

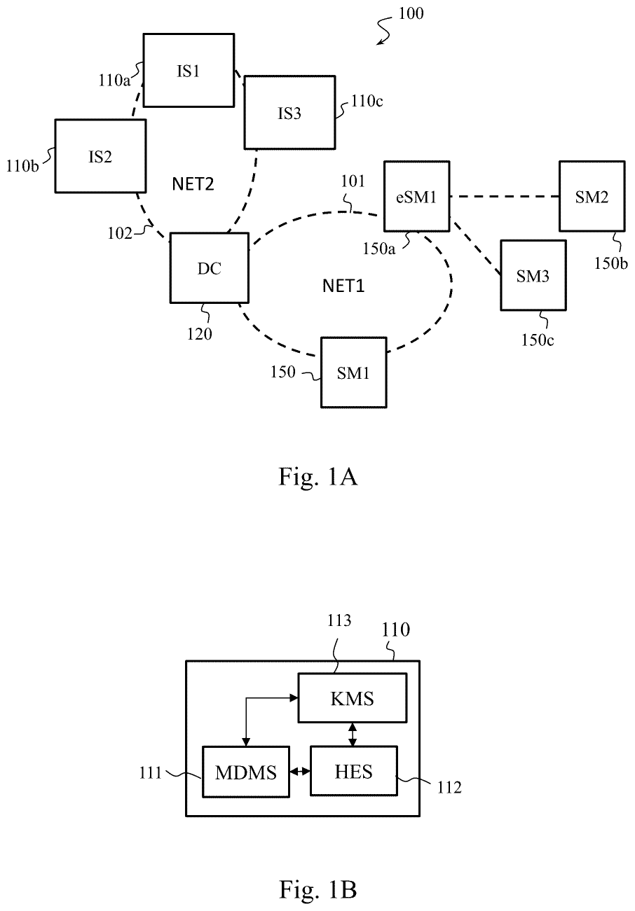

FIG. 1A illustrates schematically an automated management system 100 in which the present invention can be implemented. The automated management system 100 is configured to make a collection of consumption data resulting from measurements made by smart meters 150, 150a, 150b, 152c.

The consumption data collected are processed by several information systems IS that share one and the same collection infrastructure. Each information system is dedicated to a group of smart meters. For example, a first information system IS1 110a is dedicated to processing consumption data of a group of smart electricity meters, a second information system IS2 110b is dedicated to processing consumption data of a group of smart water meters, and a third information system IS3 110c is dedicated to processing consumption data of a group of smart gas meters. In another example, the information systems IS1 110a, IS2 110b and IS3 110c are managed by distinct operators and are dedicated to processing consumption data of respective groups of smart fluid meters (water, gas or other) that have taken out subscriptions with their respective operators.

The information systems IS1 110a, IS2 110b and IS3 110c delegate the collection of the consumption data to data concentrators DC 120, so as to distribute the collection load. Each data concentrator DC 120 thus manages a first communication network NET1 101 that serves as a collection network. Each data concentrator DC 120 thus serves as a relay between the smart meters and the information systems IS1 110a, IS2 110b and IS3 110c. As detailed below, each data concentrator DC 120 switches consumption data received through the first communication network NET1 101 coming from a said smart meter, to one or other of the information systems IS1 110a, IS2 110b, on secure links established in the collection system 100.

As schematically illustrated on FIG. 1A, the data concentrator DC 120 is external to the information systems IS1 110a, IS2 110b and IS3 110c and communicates with the information systems IS1 110a, IS2 110b and IS3 110c by means of a second communication network NET2 102.

Two types of smart meter are illustrated schematically on FIG. 1A: a first type of smart meter, which could be termed “primary smart meters” PSM, which are able to communicate via the first communication network NET1 101 and thus transmit the consumption data directly to the data concentrator DC 120 managing the first communication network NET1 101; and a second type of smart meter, which could be termed “secondary smart meters” SSM, which are not able to communicate via the first communication network NET1 101 and then transmit their consumption data to the data concentrator DC 120 managing the first communication network NET1 101 relying on a said smart meter of the first type serving as a relay.

As schematically illustrated on FIG. 1A, a said data concentrator DC 120 manages the collection of consumption data on behalf of the information system IS2 110b. The smart meters to which this collection relates include a smart meter SM2 150b (which is a secondary smart meter SSM). Said data concentrator DC 120 also manages the collection of consumption data on behalf of the information system IS3 110c. The smart meters to which this other collection relates include a smart meter SM3 150c (which is a secondary smart meter SSM). Finally, said data concentrator DC 120 manages the collection of consumption data on behalf of the information system IS1 110a. The smart meters to which this collection relates include a smart meter SM1 150 and a smart meter eSM1 150a (which are primary smart meters PSM). Unlike the smart meter SM1 150, the smart meter eSM1 150a is an enhanced smart meter that performs a gateway function on behalf of at least one other smart meter that depends on an information system IS other than the information system IS1 110a on which said smart meter eSM1 150a depends. Thus, on FIG. 1A, the smart meter eSM1 150a serves as a relay on behalf of the smart meters SM2 150b and SM3 150c.

For example, the first communication network NET1 101 is a network of the powerline communications PLC type as conforming to the G3-PLC or PRIME specifications. The primary smart meters PSM are then smart electricity meters, and therefore potentially fully operating permanently. According to another example, the first communication network NET1 101 is a wireless network of the LPWAN (“Low-Power Wide Area Network”) type as found in the Internet of Things IoT. The primary smart meters PSM can then be smart fluid meters (water, gas or other), typically powered on batteries, and therefore with intermittent operation (standby periods) in order to preserve said batteries.

For example, the second communication network NET2 102 is a wireless communication network of the 5G (5th generation) type. According to other examples the communication network NET2 102 is a wireless communication network of the GPRS (“General Packet Radio Service”), UMTS (“Universal Mobile Telecommunications System”) or LTE (“Long-Term Evolution”) type.

For example, each secondary smart meter SSM is connected to the primary smart meter PSM that serves as a relay for it by means of a communication link that conforms to the M-Bus (“Meter Bus”) remote reading specifications as defined in EN 13757-2 or to the wM-Bus (“Wireless M-Bus”) specifications as defined in EN 13757-4.

FIG. 1B illustrates schematically an arrangement of an information system IS 110 (to which the information systems IS1 110a, IS2 110b and IS3 110c correspond), in a particular embodiment. Thus the information system IS 110 comprises various components including a network head-end system (HES) 112, a meter data management system (MDMS) 111, and a key management system (KMS) 113.

The components of the information system IS 110 communicate for example using the internet, or more generally a network of the IP (“Internet Protocol”) type, or potentially using a virtual private network VPN.

The network head-end system HES 112 is configured to manage transmissions in the context of collecting consumption data.

The meter data management system MDMS 111 is configured to process the consumption data collected.

The key management system KMS 113 is configured to store encryption keys necessary for the smart meters that depend on the information system IS 110 in question. The key management system KMS 113 supplies, to the meter data management system MDMS 111, the keys necessary for the decipherings that said meter data management system MDMS 111 must perform.

Thus the key management system KMS of the information system IS1 110a manages the keys necessary to the smart meters that depend on the information system IS1 110a, the key management system KMS of the information system IS2 110b manages the keys necessary to the smart meters that depend on the information system IS2 110b, and the key management system KMS of the information system IS3 110c manages the keys necessary to the smart meters that depend on the information system IS3 110c.

In particular, the key management system KMS 113 is configured to store public asymmetric encryption keys. There is a public asymmetric encryption key AK1 for each smart meter that depends on the information system IS 110 in question. A private asymmetric encryption key AK2, which is held in the automated management system 100 solely by the smart meter in question, corresponds to each public asymmetric encryption key AK1. The private asymmetric encryption key AK2 is for example derived from a serial number of the corresponding smart meter. The public asymmetric encryption key AK1 is used for decrypting data signed by means of the corresponding private asymmetric encryption key AK2. Each pair consisting of public asymmetric encryption key AK1 and private asymmetric encryption key AK2 makes it possible to ensure non-repudiation of the consumption data transmitted (measured) by the smart meter in question to the information system IS 110 on which said smart meter depends.

Furthermore, the key management system KMS 113 is configured to store symmetric encryption keys.

There is a first symmetric encryption key SK1 for each secondary smart meter SSM, for communicating in a secure manner with the primary smart meter PSM that serves as a relay for it Thus, in the example in FIG. 1A, the key management system KMS 113 of the information system IS2 110b stores the symmetric encryption key SK1 for each secondary smart meter SSM that depends on said information system IS2 110b, including the smart meter SM2 150b. And in the example in FIG. 1A, the key management system KMS 113 of the information system IS3 110c stores the symmetric encryption key SK1 for each secondary smart meter SSM that depends on said information system IS3 110c, including the smart meter SM3 150c. There is a second symmetric encryption key SK2 for each primary smart meter PSM for communicating in a secure manner with the data concentrator DC 120. Thus, in the example in FIG. 1A, the key management system KMS 113 of the information system IS1 110a stores the symmetric encryption key SK2 for each primary smart meter PSM that depends on said information system IS1 110a, including the smart meters SM1 150 and eSM1 150a.

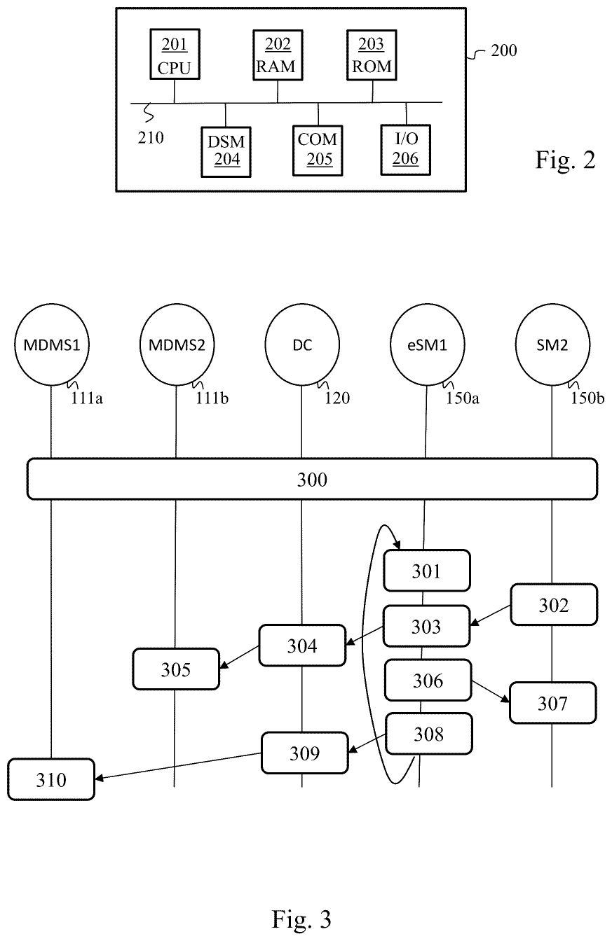

FIG. 2 illustrates schematically an example of hardware architecture 200 that is adapted to implement any device controller of the automated management system 100. The example of hardware architecture is thus adapted to implement a controller of an information system IS, or of any component of the information system IS The example of hardware architecture is also adapted to implement a controller of a data concentrator DC 120. The example of hardware architecture is also adapted to implement a controller of a primary smart meter PSM. The example of hardware architecture is also adapted to implement a controller of a secondary smart meter SSM

The hardware architecture 200 then comprises, connected by a communication bus 210: a processor or CPU (“central processing unit”) 201; a random access memory (RAM) 202; a read only memory (ROM) 203 or EEPROM (“electrically-erasable programmable ROM”), or a flash memory; a data storage medium (DSM) 204, such as a hard disk drive HDD, or a storage medium reader, such as an SD (Secure Digital) card reader; and at least one communication interface COM 205 Depending on the device concerned, the hardware architecture 200 may furthermore comprise inputs/outputs I/O 206, for example to make consumption measurements.

The processor 201 is capable of executing instructions loaded in the RAM 202 from the ROM 203, from an external memory (not shown), from a storage medium such as an SD car), or from a communication network. When the hardware architecture 200 is powered up, the processor 201 is capable of reading instructions from the RAM 202 and executing them. These instructions form a computer program causing the implementation, by the processor 201, of the steps and algorithms described here in relation to the device concerned.

All or some of the steps and algorithms described here can thus be implemented in software form by executing a set of instructions by a programmable machine, such as a DSP (“digital signal processor”) or a microcontroller, or be implemented in hardware form by a machine or a component (chip) or a set of components (chipset), such as an FPGA (field-programmable gate array) or an ASIC (application-specific integrated circuit). In general terms, each device of the automated management system 100 comprises electronic circuitry arranged and configured to implement the steps and algorithms described here in relation to the device in question.

FIG. 3 illustrates schematically exchanges occurring in the automated management system 100 for collecting consumption data.

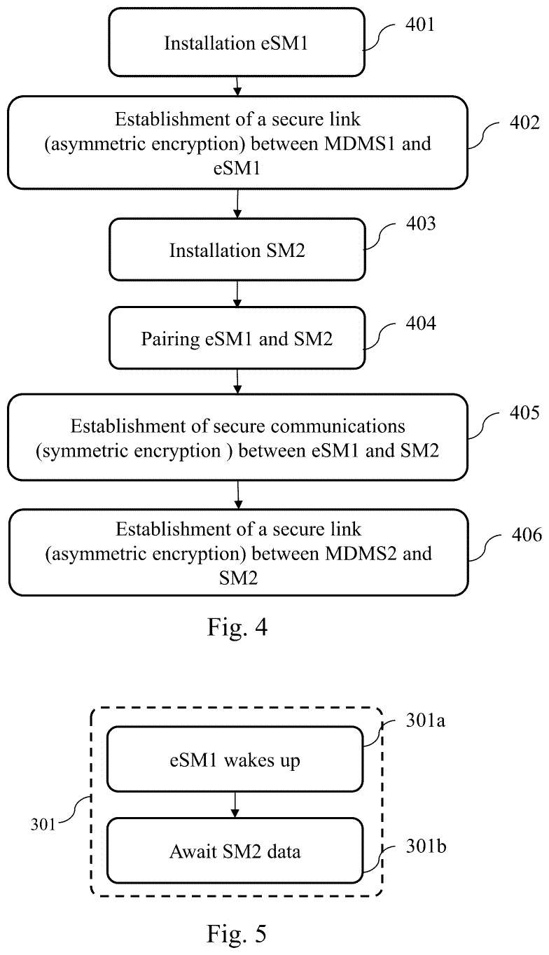

Before being able to make a collection of consumption data from the smart meter SM2 150b, a step 300 of establishing secure communications and establishing the relay by the smart meter eSM1 150a is performed. This step 300 is detailed in relation to FIG. 4.

Thus, following a step 401 of installing the smart meter eSM1 150a, a secure link is established, in a step 402, between the smart meter eSM1 150a and the information system IS1 110a, and more particularly the meter data management system MDMS 111a (marked MDMS1) of the information system IS1 110a. The meter data management system MDMS1 111a then recovers the public asymmetric encryption key associated with the smart meter eSM1 150a from the key management system KMS 113 of the information system IS1 110a. The secure link is provided by activating the asymmetric encryption between the smart meter eSM1 150a and the information system IS1 110a. This secure link is adapted to ensure non-repudiation of data supplied (measured) by the smart meter eSM1 150a and to prevent the identity of the smart meter eSM1 150a being usurped. Then, following a step 403 of installing the smart meter SM2 150b, a pairing is made between the smart meter eSM1 150a and the smart meter SM2 150b in a step 404. Example, a pressing (e.g. a long pressing) on a pushbutton of the smart meter eSM1 150a and of the smart meter SM2 150b triggers the pairing. The smart meter eSM1 150a and the smart meter SM2 150b recognise each other mutually, and configure themselves so that the smart meter eSM1 150a provides the relaying of data on behalf of the smart meter SM2 150b. Once the smart meter eSM1 150a and the smart meter SM2 150b are paired, the smart meter eSM1 150a synchronises the smart meter SM2 150b timewise and programs a future wake-up time for it. The smart meter SM2 150b can then go on standby.

In a particular embodiment, in a step 405, so as to complete the pairing between the smart meter eSM1 150a and the smart meter SM2 150b, secure communications, by symmetric encryption, are established between the smart meter eSM1 150a and the smart meter SM2 150b. To do this, the smart meter eSM1 150a obtains, from the information system IS2 110b, the symmetric encryption key to be used for communicating in a secure manner with the smart meter SM2 150b. For example, the smart meter eSM1 150a obtains said symmetric encryption key from the key management system KMS 113 associated with the MDMS 111b (marked MDMS2) of the information system IS2 110b. The smart meter eSM1 150a obtains an address (typically an IP address) for contacting an item of equipment of the information system IS2 110b, typically the meter data management system MDMS2 111b, to declare itself to be a relay on behalf of the smart meter SM2 150b and thus to obtain in return, from the key management system KMS 113, the symmetric encryption key associated with the smart meter SM2 150b.

And, in a step 406, a secure link is established between the smart meter SM2 150b and the information management system IS2 110b, and more particularly the meter data management system MDMS2 111b. The meter data management system MDMS2 111b then recovers the public asymmetric encryption key associated with the smart meter SM2 150b from the key management system KMS 113 of the information system IS2 110b. The secure link is provided by activating the asymmetric encryption between the smart meter SM2 150b and the information system IS2 110b. The secure link is provided by activating the asymmetric encryption between the smart meter SM2 150b and the information system IS2 110b. This secure link is adapted to ensure non-repudiation of data supplied (measured) by the smart meter SM2 150b and to prevent the identity of the smart meter SM2 150b being usurped.

Next a collection of consumption data from the smart meter SM2 150b is made, using the smart meter eSM1 150a as a relay.

Thus, returning to FIG. 3, in a step 301, the smart meter eSM1 150a prepares to receive consumption data coming from the smart meter SM2 150b. As detailed on FIG. 5, the smart meter eSM1 150a awakens in a step 301a and awaits, in a step 301b, consumption data coming from the smart meter SM2 150b. The smart meter eSM1 150a awakens a few moments (for example 1 second) before a programmed awakening of the smart meter SM2 150b.

It should be noted that, when the smart meter eSM1 150a is electrically powered on the mains, it is not necessary to establish standby periods at the smart meter eSM1 150a, although this does however make it possible to limit energy consumption.

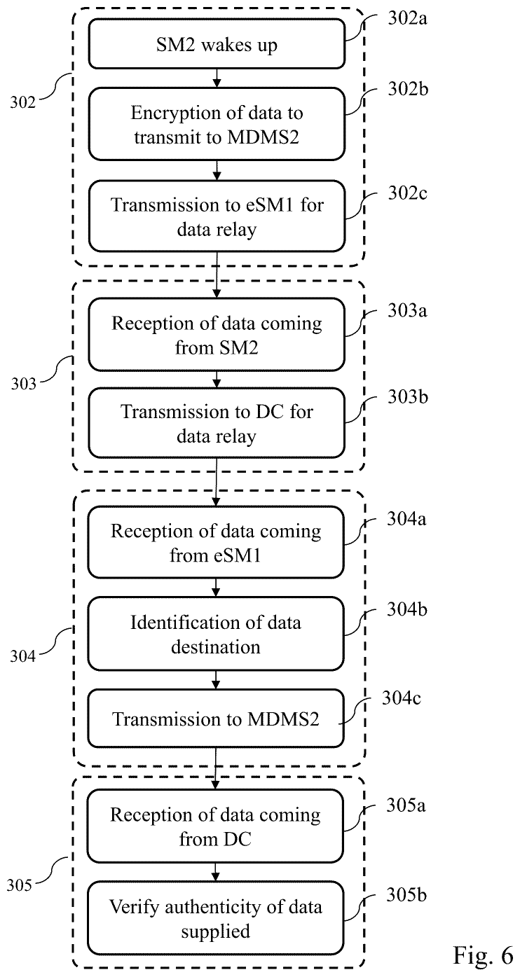

Then, in a step 302 to 305 as detailed on FIG. 6, a transfer of consumption data takes place from the smart meter SM2 150b to the information system IS2 110b (preferentially to the meter data measurement system MDMS2 111b) by means of the secure link of step 406, using the smart meter eSM1 150a as relay.

Thus, in a step 302, the smart meter SM2 150b transmits consumption data to the smart meter eSM1 150a. More precisely, in a step 302a, the smart meter SM2 150b awakens and obtains consumption data to be transmitted to the information system IS2 110b. Then, in a step 302b, the smart meter SM2 150b signs its consumption data by means of its asymmetric encryption key and transmits them to the smart meter eSM1 150a in a step 302c. The transmission between the smart meter SM2 150b and the smart meter cSM1 150a preferentially takes place in a secure manner, using the symmetric encryption key associated with the smart meter SM2 150b (i.e. the smart meter SM2 150b encrypts the data with the symmetric encryption key).

Then, in a step 303, the smart meter eSM1 150a relays data to the information system IS2 110b, passing through the data concentrator DC 120. Thus, in a step 303a, the smart meter cSM1 150a receives the data transmitted by the smart meter SM2 150b in the step 302c. In the case of secure transmission between the smart meter SM2 150b and the smart meter cSM1 150a, the smart meter eSM1 150a is capable of making a decryption, by means of the symmetric encryption key that was transmitted to it by the information system IS2 110b. And, in a step 303b, the smart meter eSM1 150a transmits the data (still signed by means of the asymmetric encryption of the smart meter SM2 150b) to the data concentrator DC 120. The transmission between the smart meter eSM1 150a and the data concentrator DC 120 preferentially takes place in a secure manner, using the symmetric encryption key associated with the smart meter eSM1 150a (i.e. the smart meter eSM1 150a encrypts the data with the symmetric encryption key). In this transmission, the smart meter eSM1 150a indicates to the data concentrator DC 120 that the destination of the data is the information system IS2 110b (preferentially, the meter data management system MDMS2 111b). Typically, a destination address field contains the IP address of the meter data management system MDMS2 111b.

Then, in a step 304, the data concentrator DC 120 forwards the consumption data coming from the smart meter SM2 150b, and relayed by the smart meter eSM1 150a, to the information system IS2 110b (preferentially to the meter data management system MDMS2 111b). Thus the data concentrator DC 120 switches the consumption data received to the information system IS2 110b, since these consumption data relate to a secure link involving the information system IS2 110b. More precisely, in a step 304a, the data concentrator DC 120 receives the data transmitted by the smart meter eSM1 150a at the step 303b. If the data were transmitted in a secure manner over the first communication network NET1 101 by the smart meter eSM1 150a, the data concentrator DC 120 uses the symmetric encryption key associated with the smart meter eSM1 150a to decrypt the data received. The data concentrator DC 120 for example obtained this symmetric encryption key from the information system IS1 110a (more precisely from the key management system KMS 113), when the smart meter eSM1 150a declared itself on the first communication network NET1 101. Then, in a step 304b, the data concentrator DC 120 identifies the destination of the data received, namely here the information system IS2 110b (preferentially the meter data management system MDMS2 111b). And, in a step 304c, the data concentrator DC 120 forwards the consumption data coming from the smart meter SM2 150b to the destination identified.

Then, in a step 305, the information system IS2 110b processes the consumption data coming from the smart meter SM2 150b. More precisely, in a step 305a, the information system IS2 110b (preferentially the meter data management system MDMS2 111b) receives the data transmitted by the data concentrator DC 120 at the step 304c. Then, in a step 305b, the information system IS2 110b (preferentially the meter data management system MDMS2 111b) verifies the authenticity of the consumption data coming from the smart meter SM2 150b by means of the public asymmetric encryption key associated with the smart meter SM2 150b. The information system IS2 110b can thus verify that the data received do actually come, via the secure link established between the smart meter SM2 150b and the information system IS2 110b, from consumption measurements made by the smart meter SM2 150b in question.

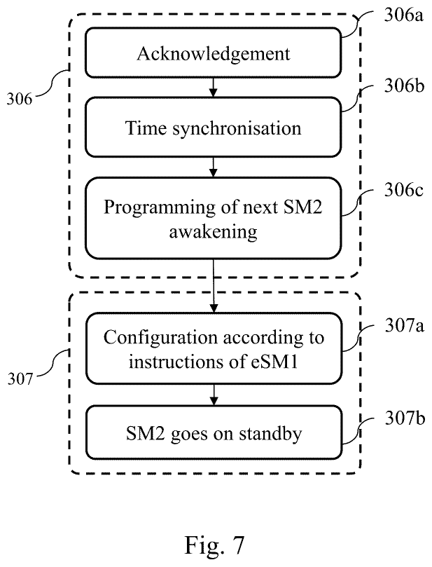

Thus, returning to FIG. 3, in a step 306, the smart meter eSM1 150a reprograms the smart meter SM2 150b for a subsequent reading of consumption data measured by said smart meter SM2 150b. More precisely, as detailed on FIG. 7, in a step 306a, the smart meter eSM1 150a acknowledges the data transmitted by the smart meter SM2 150b at the step 302c. Then, preferentially, in a step 306b, the smart meter eSM1 150a synchronises the smart meter SM2 150b timewise, for example to set the smart meter SM2 150b to the reference of Coordinated Universal Time (UTC). And, in a step 306c, the smart meter eSM1 150a programs a future wake-up time (emerging from standby) for the smart meter SM2 150b.

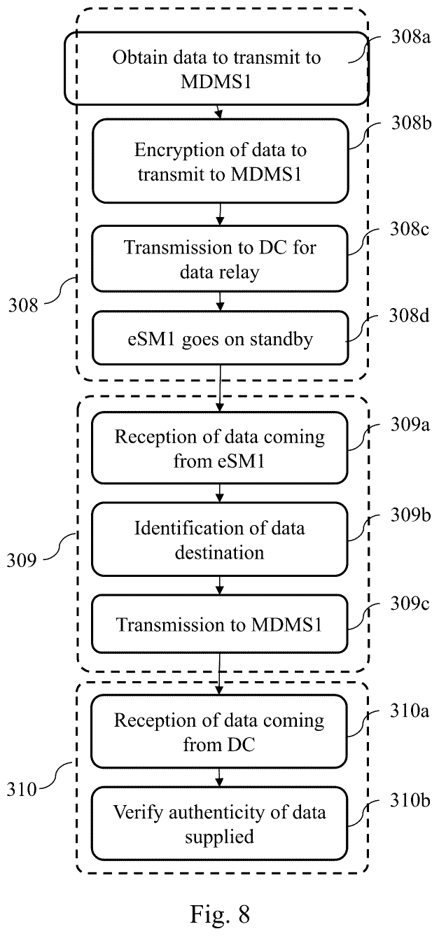

Then, in a step 307, the smart meter SM2 150b follows the instructions of the smart meter cSM1 150a and begins a period of standby until a next reading of consumption data. More precisely, as detailed on FIG. 7, in a step 307a, the smart meter SM2 150b configures itself in accordance with the instructions of the smart meter eSM1 150a: time synchronisation and programming of the next wake-up time. Then, in a step 307b, the smart meter SM2 150b goes on standby. The batteries of the smart meter SM2 150b are thus preserved. When the smart meter eSM1 150a is itself supplied by batteries, it is advantageous to profit from the awakening of the smart meter eSM1 150a to transmit its own consumption data in addition to the consumption data of the smart meter SM2 150b. Thus, in a step 308, the smart meter eSM1 150a transmits consumption data to the data concentrator DC 120, this time intended for the information system IS1 110a. More precisely, as detailed on FIG. 8, in a step 308a, the smart meter eSM1 150a obtains consumption data to be transmitted to the information system IS1 110a. Then, in a step 308b, the smart meter eSM1 150a signs its consumption data by means of its asymmetric encryption key and transmits them to the data concentrator DC 120 in a step 308c. The transmission between the smart meter eSM1 150a and the data concentrator DC 120 preferentially takes place in a secure manner, using the symmetric encryption key associated with the smart meter eSM1 150a (i.e. the smart meter eSM1 150a encrypts the data with the symmetric encryption key). In a particular embodiment, to preserve its batteries where applicable, the smart meter eSM1 150a programs its own awakening at a wake-up time prior to the programmed wake-up time of the smart meter SM2 150b and goes on standby in a step 308d.

Then, in a step 309, the data concentrator DC 120 forwards the consumption data coming from the smart meter eSM1 150a to the information system IS1 110a (preferentially to the meter data management system MDMS1 111a). Thus the data concentrator DC 120 switches the consumption data received to the information system IS1 110a, since these consumption data relate to a secure link involving the information system IS1 110a. More precisely, in a step 309a, the data concentrator DC 120 receives the data transmitted by the smart meter eSM1 150a at the step 308c. If the data were transmitted in a secure manner over the first communication network NET1 101 by the smart meter eSM1 150a, the data concentrator DC 120 uses the symmetric encryption key associated with the smart meter eSM1 150a to decrypt the data received. Then, in a step 309b, the data concentrator DC 120 identifies the destination of the data received, namely here the information system IS1 110a (preferentially the meter data management system MDMS1 111a). And, in a step 309c, the data concentrator DC 120 forwards the consumption data coming from the smart meter eSM1 150a to the destination identified.

Then, in a step 310, the information system IS1 110a processes the consumption data coming from the smart meter eSM1 150a. More precisely, in a step 310a, the information system IS1 110a (preferentially the meter data management system MDMS1 111a) receives the data transmitted by the data concentrator DC 120 at the step 309c. Then, in a step 310b, the information system IS1 110a (preferentially the meter data management system MDMS1 111a) verifies the authenticity of the consumption data coming from the smart meter eSM1 150a by means of the public asymmetric encryption key associated with the smart meter eSM1 150a. The information system IS1 110a can thus verify that the data received do actually come, via the secure link established between the smart meter eSM1 150a and the information system IS1 110a, from consumption measurements made by the smart meter eSM1 150a in question.

It is clear from the above that, by means of the relays made by the smart meter eSM1 150a on behalf of the smart meter SM2 150b, as well as by means of the secure link between each said smart meter and the information system on which the smart meter depends, the consumption data are collected effectively by means of one and the same network infrastructure (first communication network NET1 101), which is secure (non-repudiation of the data transmitted), without the various information systems (which correspond to distinct operators) having to communicate with each other.

In a particular embodiment, the data transmitted by a smart meter to the information system IS on which said smart meter depends are obtained by asymmetric encryption (signature) of a set of data including a hashcode denoted HASH calculated from the following doublet:
a serial number of the smart meter in question; and
the consumption data D coming from measurements made by the smart meter in question.

To obtain the hashcode, a hash function H(.) is used. The hash function H(.) is a particular function that, from data supplied as an input, calculates a numerical hashcode serving to quickly identify the initial data. In other words, a unique hashcode that is the result of the hash function H(.) corresponds to a unique set of data. Consequently, for two different sets of data Q1 and Q2, the smart meter in question generates two distinct hashcodes S1=H(Q1) and S2=H(Q2).

In one embodiment, the function H(.) is an SHA-2 function (for example SHA-224, SHA-256, SHA-384 or SHA-512). In the case where the function H(.) is of the SHA-256 type, the hashcode obtained HASH comprises 256 bits. In the case where the function H is of the SHA-512 type, the hashcode obtained HASH comprises 512 bits. Other functions can be used as H(.) function, such as for example an SHA-3 function, an MD4 function, an MD5 function or an SHA-1 function, all well known in the cryptography field.

In a variant embodiment, the aforementioned set of data is supplemented by stuffing bits in order to obtain an alignment on an integer number of bytes adapted to the hash function H(.) to be applied.

A concatenation of the hashcode obtained with the consumption data D is then included in the data transmitted.

Thus the information system IS concerned can verify that the data received are actually those transmitted by the smart meter in question. After deciphering using the public asymmetric encryption key associated with the smart meter in question, the information system IS (preferentially the meter data management system MDMS 111 concerned) generates a reference hashcode with the information that it holds concerning the smart meter in question. More precisely, the reference hashcode is generated in the same way as the hashcode HASH generated by said smart meter in question, using the consumption data D concatenated with the hashcode HASH and the serial number of the smart meter known from the information system IS. If the hashcode HASH and the reference hashcode coincide, then the data received are actually data transmitted by the smart meter in question.

In a particular embodiment, when the smart meter is a water meter, the consumption data D are:
a metrological water-consumption index;
a metrological backflow index, i.e. in the opposite direction of flow to the water supply;
maximum and minimum water temperature during a predetermined period, i.e. since the last reading.

In a particular embodiment, when the smart meter is a gas meter, the consumption data D are:
a metrological gas-consumption index;
maximum and minimum gas pressure during a predetermined period, i.e. since the last reading.

In a particular embodiment, when the smart meter is a heat meter, the consumption data D are:
a metrological energy-consumption index calculated from measurements of fluid temperature at the inlet and measurements of fluid temperature at the outlet, and flow measurements.

1. A method for collecting, in an automated management system, first consumption data by a first information system of the automated management system and second consumption data by a second information system of the automated management system, the automated management system further comprising a data concentrator to which the first and second information systems respectively delegate the collection of the first and second consumption data, the automated management system further comprising a communication network via which the data concentrator is connected to smart meters of a first type, the method comprising:
a pairing is made between each smart meter of a second type and a said smart meter of the first type, so as to serve as relays for collecting consumption data from the smart meter of the second type in question;
a first secure link is established between each smart meter of the first type and the first information system, the first secure link being such that an asymmetric encryption is established to transmit the first consumption data from the smart meter of the first type in question and the first information system;
a second secure link is established between each smart meter of a second type and the second information system, the second secure link being such that an asymmetric encryption is established to transmit the second consumption data from the smart meter of the second type in question and the second information system using the smart meter of the first type paired as a relay;
the data concentrator switches consumption data received through the communication network coming from a said smart meter of the first type, either to the first information system or to the second information system, on the secure link to which said received data relate from the first and second secure links.

2. The method according to claim 1, wherein each smart meter of the second type operates on batteries, and the smart meter of the first type which is paired with the smart meter of the second type in question programs times for the smart meter of the second type in question to wake up to obtain the second consumption data to be relayed via the communication network.

3. The method according to claim 2, wherein at least one smart meter of the first type paired operates on batteries, and the smart meter of the first type in question programs its own times for waking up, so as to be awakened when each smart meter of the second type paired with the smart meter of the first type in question wakes up.

4. The method according to claim 1, wherein each smart meter of the second type communicates in a secure manner by symmetric encryption with the smart meter of the first type paired that serves as a relay for it, the smart meter of the first type in question obtaining a symmetric encryption key to be used with the smart meter of the second type in question from the second information system.

5. The method according to claim 4, wherein each smart meter of the second type provides to the smart meter of the first type paired that serves as a relay for it an address of an item of equipment of the second information system from which to obtain the symmetric encryption key to be used with the smart meter of the second type in question.

6. The method according to claim 1, wherein each smart meter of the first type communicates in a secure manner by symmetric encryption with the data concentrator, the data concentrator obtaining an asymmetric encryption key to be used with the smart meter of the first type in question from the first information system.

7. An automated management system configured to make a collection of first consumption data by a first information system of the automated management system and of second consumption data by a second information system of the automated management system, the automated management system further comprising a data concentrator to which the first and second information systems respectively delegate the collection of the first and second consumption data, the automated management system further comprising a communication network via which the data concentrator is connected to smart meters of a first type, the automated management system further comprising smart meters of the second type,
the automated management system being such that each smart meter of the first type, each smart meter of the second type, the data concentrator, the first information system and the second information system comprise electronic circuitry configured so that:
a pairing is made between each smart meter of the second type and a said smart meter of the first type, so as to serve as relays for collecting consumption data from the smart meter of the second type in question;
a first secure link is established between each smart meter of the first type and the first information system, the first secure link being such that an asymmetric encryption is established to transmit the first consumption data from the smart meter of the first type in question and the first information system;
a second secure link is established between each smart meter of a second type and the second information system the second secure link being such that an asymmetric encryption is established to transmit the second consumption data from the smart meter of the second type in question and the second information system using the smart meter of the first type paired as a relay;
the data concentrator switches consumption data received through the communication network coming from a said smart meter of the first type, either to the first information system or to the second information system, on the secure link to which said received data relate from the first and second secure links.
